(19) United States
(12) Patent Application Publication
(10) Pub. No.: US 2009/0078735 A1
(43) Pub. Date: Mar. 26, 2009

(54) Hand held hemming device

(76) Inventor: Janet E. Hopkins, Cathedral City, CA (US)

Correspondence Address: Ms Janet E. Hopkins, 68110 Santiago Rd., Cathedral City, CA, 92234, US

(21) Appl. No.: 11/903,947

(22) Filed: Sep. 25, 2007

(51) Int. Cl. A41H 31/00; A41H 43/00; B25C 5/02

(52) U.S. Cl. 227/109

(57) ABSTRACT

A hand-held hemming mechanism consisting of a operating and stapling mechanism. The stapling mechanism consists of a hammer assembly, operated by a bar connected to a handle. The staples are held in place by the body, a pair of staple hold down assemblies, and the pusher plate. The staples are advanced by a compression spring mounted behind the pusher plate and contained in the rear of the body. A range of staple heights can be accommodated by this construction. A cover with measuring marks covers this upper portion of the invention. This cover also determines the amount of opening allowed for adding or replacing staples. The crimping is provided by an anvil mounted on a lower bar. This anvil has two different crimping slots for the range of staples used. There are two support bars than can be used with this device. One is configured for thin to medium thickness material that has a short hem. A second support bar is “u” shaped to provide a material accumulation for hems that are far longer. This “u” shaped bar is also used for thick material, no matter where the hem is. The support bar in use is mounted on pins that are permanently attached to a support bar actuator, which has a handle mounted to it. The anvil is machined in such a way so it is capable of being used with all staple heights and both support bars. The operating mechanism is power by using a scissor like hand motion which rotates both the upper and lower bars around a pivot pin thus forcing the staple into the material and crimping in the anvil. A wide variety of staples of different materials and colors can be used.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the hemming of material, specifically to being able to complete the process quickly and accurately using a familiar method.

2. Prior Art

The hemming of material is a process that has been practiced for millennia. These processes have included manual ones, needle and thread, manual using hand-held mechanical devices, U.S. Pat. No. 1,352,508 to Ftacek, U.S. Pat. No. 3,165,080 to Castelletti, U.S. Pat. No. 3,442,235 to Gibson, manual using externally powered devices U.S. Pat. No. 2,988,028 to Alcamo, and mechanical ones using powered machines specifically designed for that purpose U.S. Pat. No. 6,119,612 to Bottoms & Lovejoy, U.S. Pat. No. 6,186,084 to Yee. The vast majority of all these devices continue to use needle and thread.

By continuing to use the needle and thread process the time involved in producing a hem is determined by the length of the hem and the frequency of the stitch. Also, the ability to re-hem takes time as the stitches have to be removed before a hem can be re-positioned. This problem is endemic to costumes and other clothing types where hems need to be changed frequently.

None of the devices that are needle and thread based lend themselves to situations that are needed for the conditions previously stated.

A non-needle and thread approach is to use an adhesive backed, thermally activated tape, U.S. Pat. No. 3,168,749 to Cala, U.S. Pat. No. 5,006,393 to Isoe, etc. This process is even less attractive as now the hem location is permanent and additional devices are required to set them hem.

### OBJECTS AND ADVANTAGES

This invention addresses the basic problem of quickly and accurately creating a hem, by combining and improving existing techniques, a condition encountered by costumers, wardrobe staff, and others who have to frequently readjust hems.

The major departure from the prior art is to use the staple concept for creating the hem. This technology is mature and has many applications, U.S. Pat. No. 7,121,446 to Arad, Greenberg et al, U.S. Pat. No. 4,811,884 to Sato, U.S. Pat. No. 2,361,501 to Salzberg, etc.

The design changes created for this device include the ability to measure the distance of the hem (without a separate measuring device), the ability to position the hem either a few or many inches in from the edge of the material, and being able to accommodate materials of various thicknesses. Concerning the staple size, the crown is set at the standard dimension of material overlap of a seam, the leg length can vary over a fixed range, while the staple material can be made from different substances in different colors to match the fabrics and minimize the physical attachment.

The operation of the device is by the usual method employed by tailors, seamstresses, costumers and wardrobe managers, for cutting and pinking. Filling the device is straight forward.

By using staples that are quickly removable, re-hemming a garment is far easier and faster than cutting and removing thread, and then re-measuring, pinning, and re-sewing.

### SUMMARY

This hand held hemming invention is constructed in such a way as to be easy to use and accomplish all the goals set out for it. All the components required to be changed, are easily inter-changeable where they need to be, to accomplish the desired results. The unit is durable, yet light weight, easy to handle, with a familiar operation process and compact for storage or transport.

Additional Items yet undisclosed give added stability during operation.

### DRAWINGS

### Figures

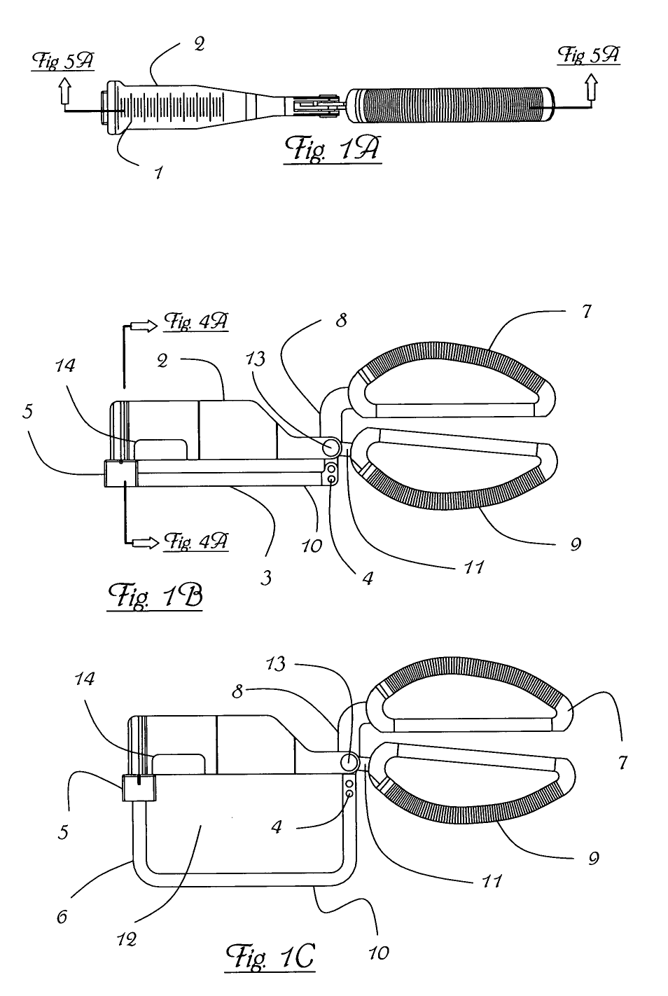

FIG. 1A shows a plan view of the invention.

FIG. 1B shows a side elevation (device closed) with the straight anvil support bar in place that is used with thin to medium fabric and has a hem close to the folded edge of the material. The staple has not yet been inserted.

FIG. 1C shows a side elevation (device closed) with a “u” shaped anvil support bar in place that would be used with thick fabric or where the hem is positioned far from the folded edge of the material. The staple has not yet been inserted.

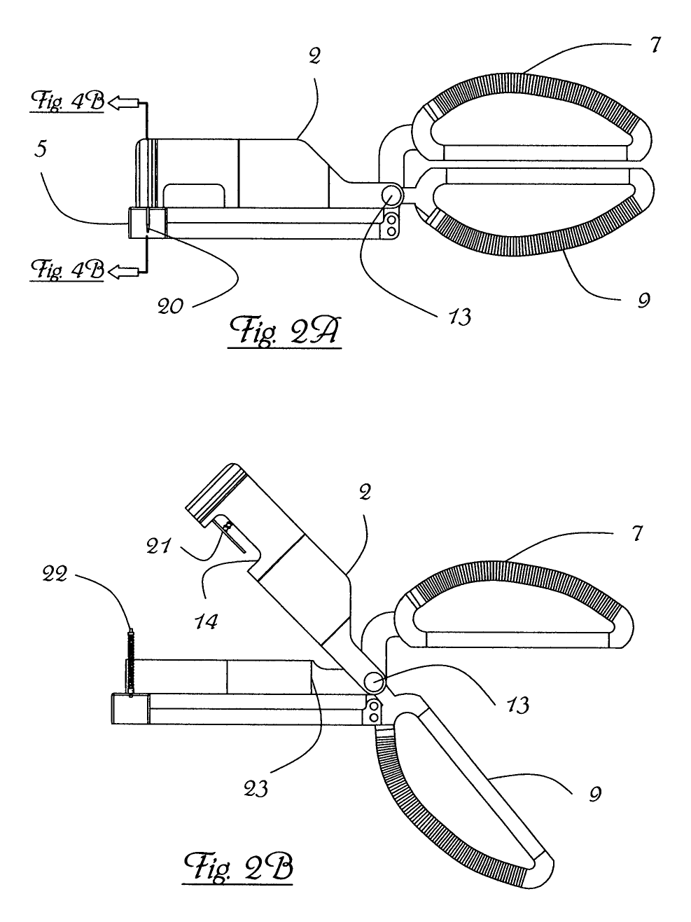

FIG. 2A shows the same view as FIG. 1B except the staple has now been inserted.

FIG. 2B shows a side elevation with the invention in the staple loading position.

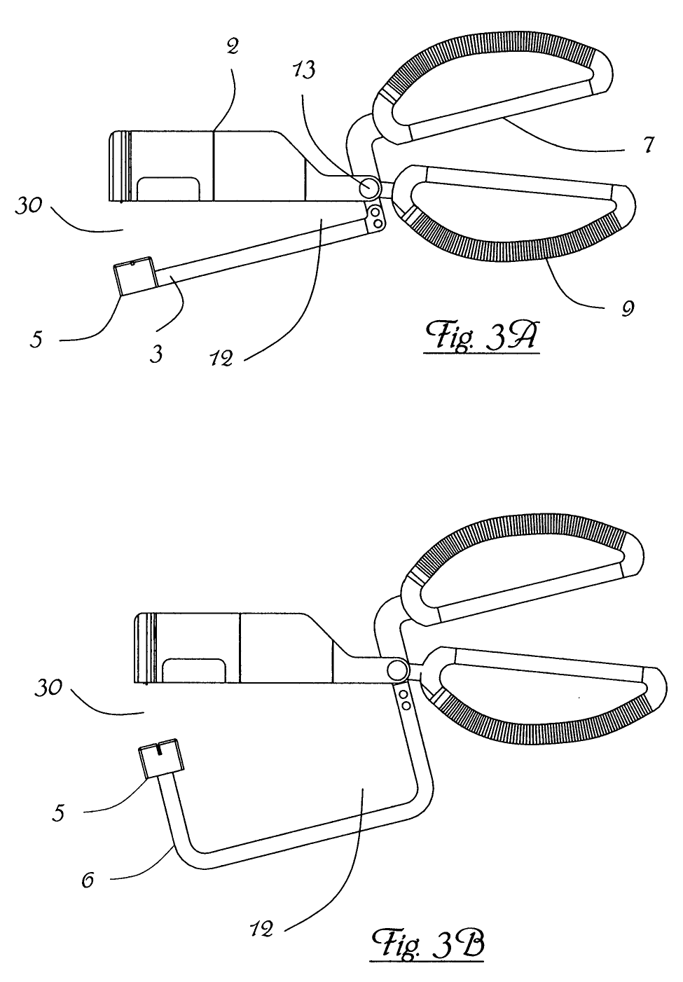

FIGS. 3A and 3B show side elevations of both configurations in the open position, the position prior to placing material into the invention.

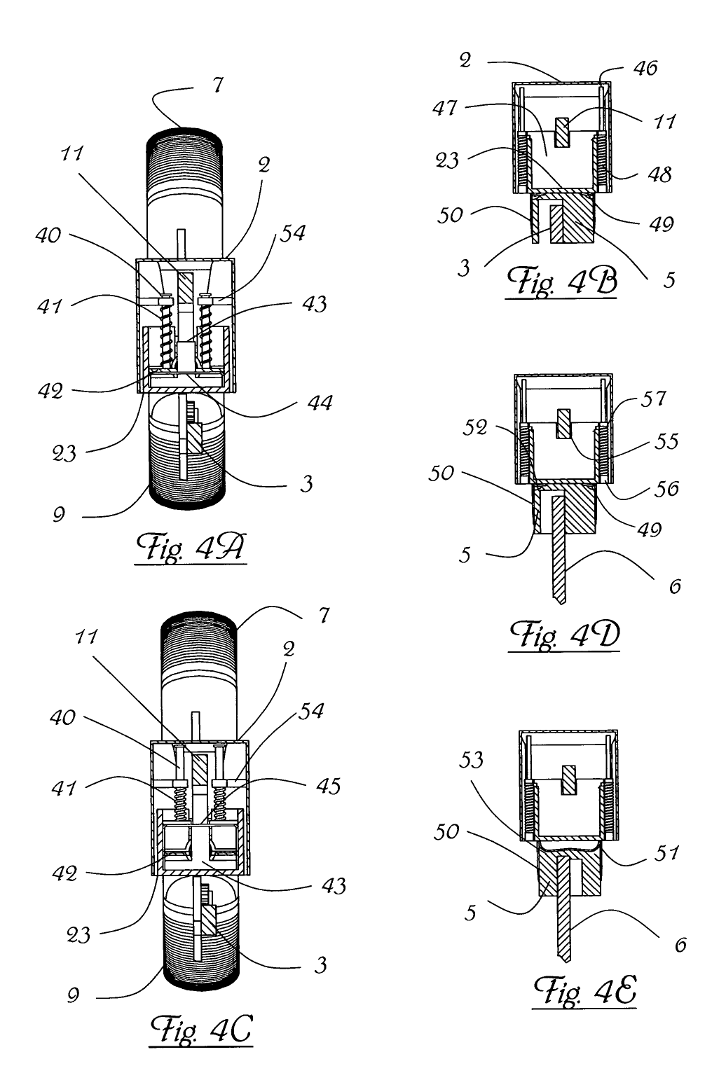

FIG. 4A is a front cross-section through the stapling mechanism with the shortest staple in place.

FIG. 4B is a front cross-section through the anvil and hammer showing the shortest staple cinched using the straight anvil support bar.

FIG. 4C is a front cross-section through the stapling mechanism with the longest staple in place.

FIG. 4D is a front cross-section through the anvil and hammer showing the shortest staple cinched using the “u” shaped support bar.

FIG. 4E is a front cross-section through the anvil and hammer showing the longest staple cinched using the “u” shaped support bar.

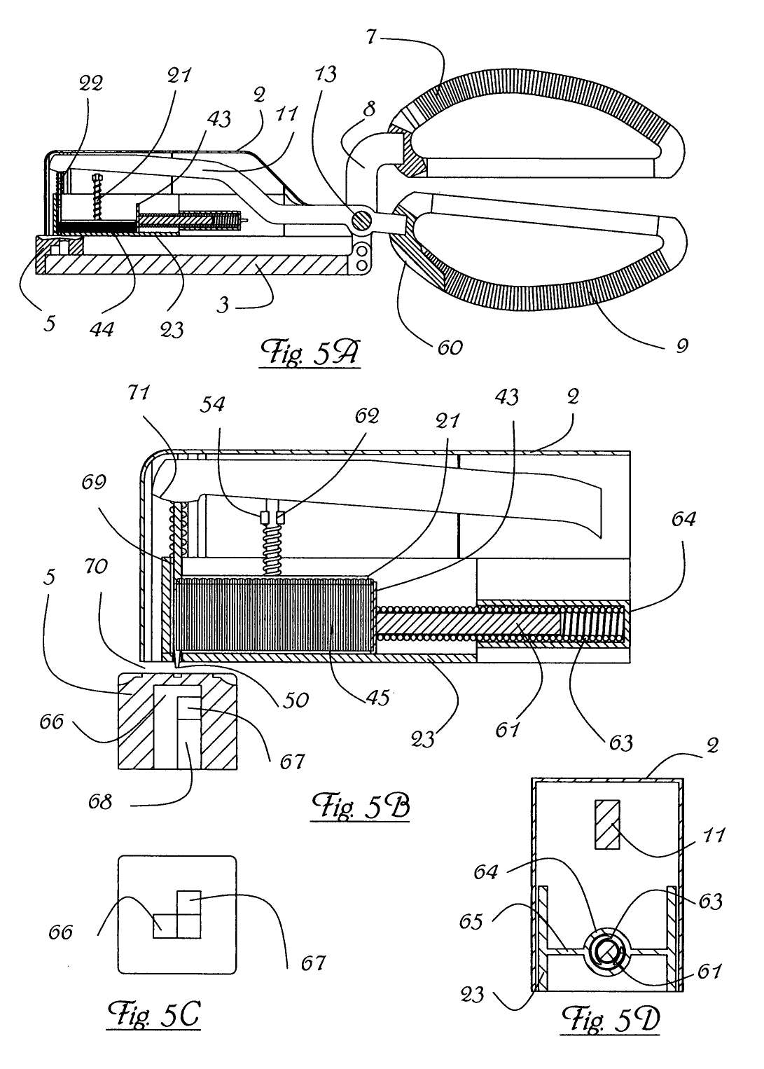

FIG. 5A shows a lateral section (device closed) with the straight anvil support bar in place that would be used with thin to medium fabric that has a hem close to the edge of the material. The staple has not yet been inserted.

FIG. 5B is an enlarged view of the inventions head end showing the various components that advance the staples. The anvil is shown in the maximum fabric thickness position.

FIG. 5C is a bottom view of the anvil showing the two pockets that are used on the “u” shaped support, depending on which staple leg length is used.

FIG. 5D is a vertical section through the staple spring advance housing.

DRAWING - Reference Numerals

| | | | |
|---|---|---|---|
| 1 | Measuring Marks | 2 | Cover |
| 3 | Anvil Support Bar-Straight | 4 | Mounting Pins |
| 5 | Staple Anvil | 6 | Anvil Support Bar-“U” Shaped |
| 7 | Upper Handle | 8 | Lower Support Bar Actuator |
| 9 | Lower Handle | 10 | Support Bar Stabilizing Surface |
| 11 | Top Bar | 12 | Material Accumulation Area |
| 13 | Hinge Pin | 14 | Finger Relief Cutouts |
| 20 | Staple Support Plate | 21 | Staple Hold-Down Assembly |
| 22 | Hammer Assembly | 23 | Body |
| 30 | Throat | 40 | Headed Pin |
| 41 | Staple Hold-Down Spring | 42 | Staple Hold-Down Plate |
| 43 | Staple Pusher Plate | 44 | Minimum Height Staple |
| 45 | Maximum Height Staple | 46 | Hammer Assembly Shaft |
| 47 | Hammer | 48 | Hammer Return Spring |
| 49 | Minimum Staple Crimped | 50 | Staple Support Plate Prong |
| 51 | Maximum Staple Crimped | 52 | Minimum Staple Crimping Slot |
| 53 | Maximum Staple Crimping Slot | 54 | Hold-Down Spring Tab |
| 55 | Hammer Notch | 56 | Hammer Assembly Shaft Lower Tab |
| 57 | Hammer Assembly Shaft Upper Tab | 60 | Support Bar Relief Slot |
| 61 | Staple Advance Spring Guide | 62 | Slot For Staple Hold-Down Assembly |
| 63 | Staple Advance Spring | 64 | Staple Advance Spring Pocket |
| 65 | Spring Pocket Support | 66 | Maximum Staple Anvil Mtg. Pocket |
| 67 | Minimum Staple Anvil Mtg. Pocket | 68 | Minimum Staple Anvil Mtg. Slot |
| 69 | Hammer Guide Slot | 70 | Maximum Height Staple Gap |
| 71 | Top Bar Tip | | |

### DETAILED DESCRIPTION OF THE PREFERRED EMBODIMENT OF THE INVENTION

Referring first to FIG. 1A, the Measuring Marks 1, shown on the top of the Cover 2, allow for the accurate placement of the hem line to the place in which the hemming is done. Depending on the needs of the user, the invention will be supplied with measurements in either the metric or inch systems.

FIG. 1B show the external Items of the invention in a side view. Item 2 is shown with Item 14, the Finger Relief Cutouts, allowing the user to open the invention. When using Item 3, the Anvil Support Bar-Straight, it is pressed on Items 4, the Mounting Pins that are permanently attached to the Lower Bar Actuator, Item 8. On the other end, the Staple Anvil, Item 5 is placed on Item 3 using the Minimum Staple Anvil Slot (See FIG. 5A), Item 68. The invention is operated by the user placing their thumb in the Upper Handle, Item 7, and their remaining fingers in the Lower Handle, Item 9, and using the same motion that is used when working with scissors. This motion causes Items 7, attached to 8 and 9 attached to Item 11, the Top Bar to rotate around the Hinge Pin, Item 13. When additional stability is needed, the invention can be rested an a flat surface using the built in flat, Item 10, Support Bar Stabilization Surface, that is on both Item 3 and the Shaped Anvil Support Bar-“U” Shaped, Item 6, FIG. 1C.

FIG. 1C is exactly the same as FIG. 1B with the exception that Item 6 replaces Item 3 and Item 5 is placed as shown on FIG. 4D. Item 12, Material Accumulation Area is where the fabric is placed when there is a very high hem.

The invention is shown when the staple has been crimped in FIG. 2A. The most noticeable Item is that Item 20, the Staple Support Plate, is extended out and is guided by Item 5. Item 20 is used to help staples that have legs with small cross-sections, not crimp prior to entering Item 5. This Item is especially helpful when encountering thick fabrics.

FIG. 2B shows the invention in the loading position. To get to this position, the user grasps Item 23, the Body, in the area of 14 and then moves 9 down raising 2. The full opening is attained by having 3 or 6 fit into a slot cut into 9, Item 60, FIG. 5A. In this position Item 21, the Staple Hold-Down Assembly is raised allowing the removal or insertion of new staples, FIG. 4A, Item 44, FIG. 4C, Item 45, by first retracting Item 43, the Staple Pusher Plate (FIGS. 4A and 4C) towards the Handles.

FIG. 3A and FIG. 3B show the invention in the open position. The opening for the introduction of material, Item 30, the Throat, is the same when using 3 or 6 being set by the configuration of 2 and 8. The amount of 12 varies because of the shape of 3 or 6.

FIG. 4A and FIG. 4C are vertical sections taken through the staple holding area of the invention showing the Minimum Height Staple, Item 44 or the Maximum Height Staple, Item 45. The staples sides and bottom are constrained by 23, while the staple top is held down by two Item 42's, the Staple Hold-Down Plate. There are two 42's because the Staple Pusher Plate, Item 43 has to accommodate the range of staples envisioned. To allow for this variation in height, 42 is attached to Item 40, Headed Pin, that has the Staple Hold-Down Spring, Item 41, trapped between the head on 40 and 42. When installing 21 (FIG. 2B), 41 is compressed towards 42 and is inserted through Item 62 (FIG. 5B), Slot For Headed Pin Assembly, in Item 54, Hold-Down Spring Tab, that is molded into 2. Now the force of 41 is between 2 and 42, holding the staples in place within the range of their height. Item 21 is unable to rotate due to the length of 42 and the distance from the inside wall of 2 and the location of the mounting hole in 54.

FIG. 4B and FIG. 4D are vertical sections taken through the stapling mechanism, showing Item 49, Minimum Staple Crimped in Item 52, the Minimum Staple Crimping Slot. The difference between these two figures is which support bar is used (3, FIG. 4B or 6, FIG. 4D). The crimping is the result of the user squeezing 7 and 9 together (FIG. 2A). This action presses 11, FIG. 1B, down into Item 55, the Hammer Notch, in Item 47, the Hammer. Item 47 moves up and down on Item 46, the Hammer Assembly Shaft, that is pressed into Item 56, Hammer Assembly Shaft Lower Tab, part of 23. The Hammer, is guided by fitting in Item 69, Hammer Guide Slot in 23 (FIG. 5A), and Item 57, a Hammer Assembly Shaft Upper Tab that is part of 47. Item 50, the Staple Support Plate Prong, brackets 5, when extended. When 50 retracted, it protrudes slightly to allow the user to position the material. This is the part of 47 that is supports and inserts staple. Item 48, the Hammer Return Spring, returns 47 to the starting position allowing the staples to advance, see FIG. 5B.

FIG. 4E is the same view as FIG. 4B and FIG. 4D, but showing Item 51, Maximum Height Staple Crimped, in Item 53, the Maximum Staple Crimping Slot. The position of 5 on 6 is critical, see FIG. 5B.

FIG. 5A is a vertical section, taken axially, that shows the internal components, especially the staple management ones, 21, 22, 23, and 43. The view shows the Minimum Staple, 44, in place. Also shown more clearly in this view is the Support Bar Relief Slot, 60.

FIG. 5B is an enlarged partial view of FIG. 5A that shows more detail. It also shows the Maximum Height Staple, 45, in place. This additional detail shows how 43 is powered to move the staples forward. Item 61, Staple Advance Spring Inner Support is attached to 43 and extends into the Inside Diameter of the Staple Advance Spring, Item 63, to give support to the spring. Item 63, is seated against the back wall in Item 64, the Staple Advance Spring Pocket. When 5 is used with 45, it must be positioned on 6, in Item 66, Maximum Anvil Mounting Pocket. This causes Item 70, the Maximum Staple Height Gap. Item 5 is designed and manufactured In a way that allows it to be used for any staple in the design range on either 3 or 6. When using 44, 5 is placed on 3, using Item 68, the Minimum Staple Mounting Slot. When using 44 and 6, Item 5 is located using the Minimum Staple Mounting Pocket, Item 67. With this configuration, there is no 70 (gap). Note, Item 71, Top Bar Tip, shows it's radius that allows an action that is non-binding between 11 and 47.

FIG. 5C shows the bottom view of 5, with the various mounting pockets shown. This configuration allows for 5 to be the only Staple Anvil needed for either Support Bar or Staple size.

FIG. 5D is a vertical section taken laterally through the Staple Advance mechanism. This section shows in detail how 64 is support by Item 65, the Spring Pocket Support, and how these are attached to 23.

I claim:

1. A hand-held hemming device comprising a stapling mechanism operated by applying force through two handles,
a replaceable bar that mounts to the upper handle, that allows for a range of material thicknesses and hem locations,
an upper bar that is connected to the lower handle that operates the staple insertion device,
a cover that has measuring marks for locating the hem distance and covers the staples and stapling mechanism,
a staple hold-down mechanism consisting of a plate, headed pins, and compression springs the allow for the vertical location of a range of staple heights, a body that contains the staples, and locates the pivot point for mounting the handles and cover,
a staple insertion mechanism that inserts the staples, has prongs to help the user locate the material, support the staples to prevent premature bending or folding, and has a spring return system,
a position to add or replace staples,
a method using a compression spring to advance the staples,

2. The apparatus of claim 1 uses staples with the crown (width) to be, but not exclusively, ⅝″ (15.9 mm), a standard sewing measurement.

3. The height of the staples in claim 2 will have a range of, but not limited to, ⅛″ (3.2 mm) to ⅜″ (9.5 mm).

4. The thickness of the staples in claim 2 will be, but not exclusively, 0.04″ (1 mm).

5. The material of the staples in claim 2 will be non-corroding, capable of normal cleaning processes, cleaning temperatures and cleaning agents.

6. The staples in claim 2 should be in various colors to match the material.

7. The handles in claim 1 are designed in such a way as to be used by left or right handed users and are elongated to allow the user to move the point where the force is supplied to crimp the staple regardless of the material thickness.

8. The measuring marks in claim 1 will be supplied in any measuring system required.

9. The measuring marks in claim 1 can be either permanently engraved on the cover or can be attached as a label.
